(19) United States
(12) Patent Application Publication
(10) Pub. No.: US 2026/0254130 A1
(43) Pub. Date: Aug. 27, 2026

(54) REPEATED THZ LINK

(71) Applicant: Attotude Inc., Menlo Park, CA (US)

(72) Inventors: Rene Schmogrow, Santa Clara, CA (US); Daniel Francis Semrau, Campbell, CA (US); David F. Welch, Atherton, CA (US); Joy Laskar, Mountain View, CA (US)

(21) Appl. No.: 19/551,136

(22) Filed: Feb. 26, 2026

Related U.S. Application Data
(60) Provisional application No. 63/763,726, filed on Feb. 26, 2025.

(51) Int. Cl. H01Q 19/13; H01Q 5/40

(52) U.S. Cl. CPC H01Q 19/13; H01Q 5/40

(57) ABSTRACT

Systems and methods include a network element comprising inbound and outbound electrical interfaces and a signal conditioning circuit. The inbound electrical interface comprises an inbound antenna and inbound circuitry coupled to the inbound antenna. The inbound antenna receives an inbound transmission signal from an inbound THz waveguide and generates an antenna output signal based thereon. The inbound circuitry receives the antenna output signal and generates an on-chip signal based thereon. The signal conditioning circuit receives the on-chip signal and modifies the on-chip signal to generate a modified on-chip signal based thereon. The outbound electrical interface comprises an outbound antenna and outbound circuitry coupled to the outbound antenna. The outbound circuitry receives the modified on-chip signal and generates an antenna feed signal based thereon. The outbound antenna receives the antenna feed signal, generates an outbound transmission signal based thereon, and couples the outbound transmission signal into an outbound THz waveguide.

### CROSS-REFERENCE TO RELATED APPLICATION

This application claims priority to the provisional patent application identified by U.S. Ser. No. 63/763,726, filed Feb. 26, 2025, the entire content of which is hereby expressly incorporated herein by reference.

### BACKGROUND ART

Conventional systems for transmitting electromagnetic waves through waveguides face fundamental limitations due to exponential signal loss during propagation. This inherent signal attenuation constrains the maximum transmission distance achievable, even in systems utilizing low-loss transmission media such as silica optical fiber, which exhibits losses of approximately 0.2 decibels (dB) per kilometer (km). To address this limitation, prior art systems commonly employ a series of signal amplifiers or repeaters positioned at intervals along the transmission path to restore signal power.

In the specific context of electromagnetic wave transmission systems operating in the Terahertz (THz) or sub-Terahertz frequency ranges, current implementations are limited to configurations without intermediate amplification stages. This restriction significantly impacts the achievable transmission distances in such systems.

A further limitation inherent to waveguide-based transmission systems stems from their dispersive characteristics, wherein electromagnetic waves of different frequencies propagate at different group velocities through the transmission medium. This frequency-dependent propagation results in temporal broadening of transmitted pulses and consequent inter-symbol interference (ISI). Contemporary coherent transmission systems typically mitigate these dispersive effects through the implementation of digital signal processing techniques at either the receiver end, the transmitter end, or both. Another approach, though less commonly used in contemporary coherent transmission systems, involves the installation of dispersion compensating modules such as fiber Bragg gratings (FBG) or dispersion-compensating fiber (DCF), for example.

### SUMMARY

The present disclosure includes a repeater architecture utilizing a gain block (i.e., amplifier) that provides gain in the THz transmission spectrum. The amplifier's interfaces are coupled to THz waveguides through which the THz signal is coupled into a semiconductor chip comprising the amplifier from a first THz waveguide, amplified, and then the amplified signal is coupled into a second waveguide from the output of the semiconductor chip. Each waveguide interface connects to a transmission THz waveguide via mode converters or tapers, and the amplifier's power supply can be delivered remotely through conductive layers in the THz waveguide.

Aspects of the present disclosure may increase the reach of a transceiver pair (e.g., from ~100 m to between 1 km and 10,000 km), with the signal-to-noise ratio (SNR) being the primary limiting factor due to amplifier noise. In addition to loss compensation, the system incorporates circuitry that mirrors the signal spectrum, swapping frequencies above and below the carrier frequency. Transmitting a mirrored and dispersed signal along an equally dispersive waveguide may result in zero net dispersion at the receiver, while also equalizing non-flat loss. Unlike optical systems using phase conjugators, the systems and methods of the present disclosure may achieve phase conjugation with one or more mixers.

In a first aspect, the present disclosure includes a network element, comprising: an inbound electrical interface comprising an inbound antenna configured to be coupled to an inbound Terahertz (THz) waveguide and operable to receive an inbound transmission signal from the inbound THz waveguide and generate an antenna output signal based on the inbound transmission signal, the inbound transmission signal being a radiated electromagnetic wave coupled into the inbound THz waveguide and configured to have client data encoded therein and an inbound carrier frequency in a range from 300 Gigahertz (GHz) to 3 THz, the inbound electrical interface further comprising inbound circuitry coupled to the inbound antenna and operable to receive the antenna output signal from the inbound antenna and generate an on-chip signal based on the antenna output signal; a signal conditioning circuit operable to receive the on-chip signal from the inbound electrical interface and modify the on-chip signal to generate a modified on-chip signal based on the on-chip signal; and an outbound electrical interface comprising an outbound antenna configured to be coupled to an outbound THz waveguide, the outbound electrical interface further comprising outbound circuitry coupled to the outbound antenna and operable to receive the modified on-chip signal from the signal conditioning circuit and generate an antenna feed signal based on the modified on-chip signal, the outbound antenna being operable to receive the antenna feed signal from the outbound circuitry, generate an outbound transmission signal based on the antenna feed signal, and couple the outbound transmission signal into the outbound THz waveguide, the outbound transmission signal being a radiated electromagnetic wave configured to have the client data encoded therein and an outbound carrier frequency in the range from 300 GHz to 3 THz.

In a second aspect, the present disclosure includes a network element, comprising: a first inbound electrical interface comprising a first inbound antenna configured to be coupled to a first inbound Terahertz (THz) waveguide and operable to receive a first inbound transmission signal from the first inbound THz waveguide and generate a first antenna output signal based on the first inbound transmission signal, the first inbound electrical interface further comprising first inbound circuitry coupled to the first inbound antenna and operable to receive the first antenna output signal from the first inbound antenna and generate a first on-chip signal based on the first antenna output signal, the first inbound transmission signal being a radiated electromagnetic wave coupled into the first inbound THz waveguide and configured to have first client data encoded therein and a first inbound carrier frequency in a range from 300 Gigahertz (GHz) to 3 THz; a second inbound electrical interface comprising a second inbound antenna configured to be coupled to a second inbound THz waveguide and operable to receive a second inbound transmission signal from the second inbound THz waveguide and generate a second antenna output signal based on the second inbound transmission signal, the second inbound electrical interface further comprising second inbound circuitry coupled to the second inbound antenna and operable to receive the second antenna output signal from the second inbound antenna and generate a second on-chip signal based on the second antenna output signal, the second inbound transmission signal being a radiated electromagnetic wave coupled into the second inbound THz waveguide and configured to have second client data encoded therein and a second inbound carrier frequency in the range from 300 GHz to 3 THz; a signal conditioning circuit operable to receive the first on-chip signal from the first inbound electrical interface and the second on-chip signal from the second inbound electrical interface and modify the first on-chip signal to generate a first modified on-chip signal based on the first on-chip signal and the second on-chip signal to generate a second modified on-chip signal based on the second on-chip signal; a first outbound electrical interface comprising a first outbound antenna configured to be coupled to a first outbound THz waveguide, the first outbound electrical interface further comprising first outbound circuitry coupled to the first outbound antenna and operable to receive the first modified on-chip signal from the signal conditioning circuit and generate a first antenna feed signal based on the first modified on-chip signal, the first outbound antenna being operable to receive the first antenna feed signal from the first outbound circuitry, generate a first outbound transmission signal based on the first antenna feed signal, and couple the first outbound transmission signal into the first outbound THz waveguide, the first outbound transmission signal being a radiated electromagnetic wave configured to have a first outbound carrier frequency in the range from 300 GHz to 3 THz; and a second outbound electrical interface comprising a second outbound antenna configured to be coupled to a second outbound THz waveguide, the second outbound electrical interface further comprising second outbound circuitry coupled to the second outbound antenna and operable to receive the second modified on-chip signal from the signal conditioning circuit and generate a second antenna feed signal based on the second modified on-chip signal, the second outbound antenna being operable to receive the second antenna feed signal from the second outbound circuitry, generate a second outbound transmission signal based on the second antenna feed signal, and couple the second outbound transmission signal into the second outbound THz waveguide, the second outbound transmission signal being a radiated electromagnetic wave configured to have a second outbound carrier frequency in the range from 300 GHz to 3 THz.

The foregoing summary provides an overview of certain selected implementations or embodiments disclosed herein, and is not intended to describe every aspect, embodiment, implementation, feature, or advantage of the disclosure exhaustively or comprehensively. Therefore, this summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

Implementations of the above techniques include methods, apparatus, systems, and computer program products are described. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a frequency-wavelength diagram of the electromagnetic (EM) spectrum;

FIG. 2 is a block diagram of an exemplary embodiment of a transport network constructed in accordance with the present disclosure;

FIG. 3 is a block diagram of an exemplary embodiment of a user device of the transport network shown in FIG. 2;

FIG. 4 is a block diagram of an exemplary embodiment of a network administrator device of the transport network shown in FIG. 2;

FIG. 5 is a block diagram of an exemplary embodiment of a first network element of the transport network shown in FIG. 2;

FIG. 6 is a block diagram of an exemplary embodiment of a second network element of the transport network shown in FIG. 2, wherein one or more antennas of the second network element are edge-coupled antennas;

FIG. 7 is a block diagram of another exemplary embodiment of a second network element of the transport network shown in FIG. 2, wherein one or more antennas of the second network element are vertically-coupled antennas;

FIG. 8 is a block diagram of an exemplary embodiment of a signal conditioning circuit of the second network element shown in FIG. 7;

FIG. 9 is a block diagram of another exemplary embodiment of the signal conditioning circuit of the second network element shown in FIG. 7;

FIG. 10 is a block diagram of an exemplary embodiment of a spectrum mirroring circuit of the signal conditioning circuit shown in FIG. 9; and

FIG. 11 is a block diagram of another exemplary embodiment of the spectrum mirroring circuit of the signal conditioning circuit shown in FIG. 9.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. That is, the use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the disclosure as described herein. Where a range of numerical values is stated herein as being less than a stated value, the range is nevertheless bounded on its lower end by a non-zero value. It is not intended that the scope of the disclosure be limited to the specific values recited when defining a range. All ranges are inclusive and combinable.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

As used herein, “circuitry” may be analog and/or digital components, or one or more suitably programmed processors (e.g., microprocessors) and associated hardware and software, or hardwired logic. Also, “components” may perform one or more functions. The term “processing component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

As used herein, “software” may include one or more computer readable instruction that when executed by one or more component (e.g., a processor) causes the component to perform a specified function. It should be understood that the algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, a phase change memory, combinations thereof, and/or the like. Such non-transitory computer-readable media may be electrically based, optically based, magnetically based, material-phase based, resistive based, and/or the like. Further, the messages described herein may be generated by the components and result in various physical transformations.

As used herein, “hollow waveguide” refers to a structure that guides waves by restricting transmission of energy in a particular direction. In the context of the present disclosure, “hollow waveguide” may refer to an optical fiber having a waveguide core operable to propagate RF signals in the THz frequency band or a routed waveguide operable to propagate RF signals in the THz frequency band.

As used herein, “THz waveguide” refers to a structure that guides waves in the THz band by propagating the waves in a particular direction and restricting transmission of energy in another direction. An example of the THz waveguide described herein is a hollow waveguide.

As used herein, a “mode” refers to a unique distribution of electric and magnetic fields which repeat along the length of a THz waveguide by which electromagnetic energy may be transported through the THz waveguide. “Single-mode” refers to a THz waveguide designed to carry only one mode of electromagnetic wave. This is achieved by having a narrow core diameter, which allows only one mode of light to propagate at a time. On the other hand, “multi-mode” refers to a THz waveguide designed to carry multiple modes of electromagnetic waves simultaneously. This is possibly due to its larger core diameter, which enables multiple modes to be propagated.

As used herein, “diameter” refers to a straight line passing from side to side through the center of a body or figure. In some embodiments, the body or figure has a circular shape having a single diameter or an elliptical shape having multiple different diameters.

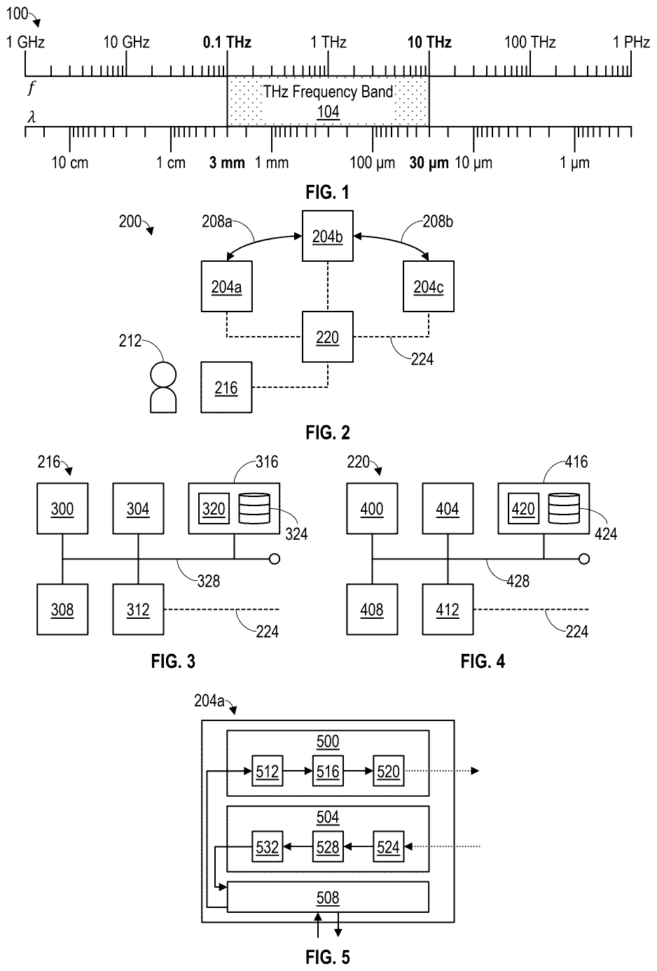

Referring now to the drawings, and in particular to FIG. 1, shown therein is a frequency-wavelength diagram of the electromagnetic (EM) spectrum 100. As shown in FIG. 1, frequency and wavelength have an inverse relationship; that is, as the frequency of a signal increases, the wavelength of the signal decreases, and vice versa. The present disclosure is generally related to transport networks (shown in FIG. 2) and network elements (shown in FIG. 2) that communicate using signals comprising radiated electromagnetic waves coupled into THz waveguides, such as a hollow waveguide. Such signals generally have a frequency in what is referred to as the Terahertz (THz) frequency band 104, which corresponds to frequencies in a range from 0.1 THz to 10 THz and wavelengths in a range from 3 millimeters (mm) to 30 micrometers (μm). However, in some embodiments, the signals may have a frequency in a different range, such as from 100 Gigahertz (GHz) to 10 THz, from 300 GHz to 3 THz, or from 500 GHz to 3 THz, for example.

Referring now to FIG. 2, shown therein is a block diagram of an exemplary embodiment of a transport network 200 constructed in accordance with the present disclosure. As shown in FIG. 2, the transport network 200 generally comprises a plurality of network elements 204a-n (hereinafter, the “network elements 204”) (e.g., a first network element 204a, a second network element 204b, and a third network element 204c shown in FIG. 2) which may communicate with each other using one or more THz waveguides shown and described herein by way of example as hollow waveguides 208a-n (hereinafter, the “hollow waveguides 208”) (e.g., a first hollow waveguide 208a and a second hollow waveguide 208b shown in FIG. 2). The THz waveguides may comprise a dielectric material. In some embodiments, the dielectric material of the THz waveguides may be selected from a group consisting of: high-resistivity float zone silicon (HRFZ-Si), germanium (Ge), and diamond-like carbon (DLC). In some embodiments, the THz waveguides are constructed of a non-polymer material. The non-polymer material may be a material that performs as a semiconductor material at a frequency less than the THz frequency band 104, and as a dielectric material at a frequency within the THz frequency band 104. High-resistivity float zone silicon (HRFZ-Si), germanium (Ge), and diamond-like carbon (DLC) are examples of non-polymer materials that perform as a semiconductor material at a frequency less than the THz frequency band 104, and as a dielectric material at a frequency within the THz frequency band 104.

While three of the network elements 204 are shown in FIG. 2, it should be understood that the transport network 200 may comprise a number of the network elements 204 that is greater or less than three. Further, while two of the hollow waveguides 208 are shown in FIG. 2, it should be understood that the transport network 200 may comprise a number of the hollow waveguides 208 that is greater or less than two.

In some embodiments of the transport network 200, a user 212 may interact with the transport network 200 using a user device 216 that may be used to request, such as from a network administrator device 220, a user interface application (shown in FIG. 3) which may be operable to accept input from the user 212 which may be transmitted to at least one of the network elements 204. In some such embodiments, the network administrator device 220 may be connected to the transport network 200 and the user device 216 via a communication network 224.

The communication network 224 may interface by optical and/or electronic interfaces and/or use a variety of network topographies and/or protocols to permit bidirectional interface and/or communication of signals and/or data between the network elements 204, the user device 216, and the network administrator device 220. The communication network 224 may interface with the network elements 204, the user device 216, and the network administrator device 220 in a variety of ways. For example, in some embodiments, the communication network 224 may be the World Wide Web (i.e., the Internet). In some such embodiments, a user interface of the transport network 200 may be delivered through a series of web pages or private internal web pages of a company or corporation, which may be written in Hypertext Markup Language (HTML), Hypertext Preprocessor (PHP), or Javascript, for example, and may be accessible by the user device 216. It should be noted that the user interface of the transport network 200 may be another type of interface including, but not limited to, a desktop application such as a Windows-based application, a Linux-based application, or a macOS-based application, for example; a web browser interface; a command-line interface; a graphical user interface (GUI); a cloud-based interface; an API interface; a server-based application; a tablet-based application; a mobile web interface; an application running on a mobile device; a virtual-reality interface; an augmented-reality interface; a touch screen interface; a voice- or gesture-controlled interface; a wearable device interface; and/or the like.

While the communication network 224 is described above as being the World Wide Web (i.e., the Internet), it should be noted that the communication network 224 may be almost any type of network and may be implemented as a Local Area Network (LAN), a Wide-Area Network (WAN), a Low-Power Wide-Area Network (LPWAN), a Long Range (LoRa) network, a metropolitan network, a wireless network, a Wi-Fi network, a cellular network, a Bluetooth network, a Global System for Mobile Communications (GSM) network, a Code Division Multiple Access (CDMA) network, a Third Generation (3G) network, a Fourth Generation (4G) network, a Long Term Evolution (LTE) network, a Fifth Generation (5G) network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

In some embodiments, the transport network 200 may be deployed in environments where local power supplies are unavailable, such as within submarine or underwater cables, for example.

The number of devices and/or networks illustrated in FIG. 2 is provided for explanatory purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the transport network 200 may perform one or more functions described as being performed by another one or more of the devices of the transport network 200. Devices of the transport network 200 may interconnect via wired connections, wireless connections, or a combination thereof.

Referring now to FIG. 3, shown therein is a block diagram of an exemplary embodiment of the user device 216 of the transport network 200 constructed in accordance with the present disclosure. In some embodiments, the user device 216 may include, but is not limited to, implementation as a personal computer, a cellular telephone, a smart phone, a network-capable television set, a tablet, a laptop computer, a desktop computer, a network-capable handheld device, a server, a digital video recorder, a wearable network-capable device, a virtual reality (VR)/augmented reality (AR) device, and/or the like.

As shown in FIG. 3, the user device 216 generally includes one or more user input devices 300a-n (hereinafter, the “user input device 300”), one or more user output devices 304a-n (hereinafter, the “user output device 304”), one or more user processors 308a-n (hereinafter, the “user processor 308”), one or more user communication devices 312a-n (hereinafter, the “user communication device 312”), and one or more user memories 316a-n (hereinafter, the “user memory 316”) storing one or more user software applications 320a-n (hereinafter, the “user software application 320”) comprising processor-executable instructions and/or one or more user databases 324a-n (hereinafter, the “user database 324”). The user input device 300, the user output device 304, the user processor 308, the user communication device 312, and the user memory 316 may be connected via a user path 328 such as a data bus that permits communication among the components of the user device 216.

The user input device 300 may be capable of receiving information input from the user processor 308 and/or the user 212, and transmitting such information to other components of the user device 216 and/or the communication network 224. The user input device 300 may include, but is not limited to, implementation as a keyboard, a touchscreen, a mouse, a trackball, a microphone, a camera, a fingerprint reader, an infrared port, an optical port, a cell phone, a smart phone, a Personal Digital Assistant (PDA), a remote control, a fax machine, a wearable communication device, a network interface, combinations thereof, and/or the like, for example.

The user output device 304 may be capable of outputting information in a form perceivable by the user processor 308 and/or the user 212. The user output device 304 may include, but is not limited to, implementation as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the user input device 300 and the user output device 304 may be implemented as a single device, such as, for example, a touchscreen of a computer, a tablet, or a smartphone. It is to be further understood that as used herein the term “user” (i.e., the user 212) is not limited to a human being, and may comprise a computer, a server, a website, a processor, a network interface, a user terminal, a virtual computer, combinations thereof, and/or the like, for example. The user output device 304 may display the user interface on the user device 216.

The user processor 308 may include, but is not limited to, implementation as a processor, a microprocessor, a mobile processor, a System on a Chip (SoC), a Central Processing Unit (CPU), a Microcontroller (MCU), a Digital Signal Processor (DSP), an Application Specific Integrated Circuit (ASIC), a Field Programmable Gate Array (FPGA), a Tensor Processing Unit (TPU), a Graphics Processing Unit (GPU), a combination of hardware and software, and/or the like. The user processor 308 may be capable of communicating with the user input device 300, the user output device 304, the user communication device 312, and/or the user memory 316 via the user path 328. The user processor 308 may include one or more of the user processor 308 working together or independently and located locally or remotely (e.g., accessible via the communication network 224).

The user communication device 312, in communication with the user processor 308, may interface with the communication network 224. For example, the user processor 308 may be capable of communicating via the communication network 224 by exchanging signals (e.g., analog, digital, optical, and/or the like) via one or more ports (e.g., physical or virtual ports) using a network protocol to communicate signals and/or data with the network administrator device 220 and/or transport network 200.

The user memory 316 may comprise one or more non-transitory processor-readable media. The user memory 316 may store the user software application 320 that, when executed by the user processor 308, causes the user device 216 to perform an action such as communicate with or control one or more component of the user device 216 and/or, via the communication network 224, the transport network 200. The user memory 316 may include one or more of the user memory 316 working together or independently to store processor-executable code and may be located locally or remotely (e.g., accessible via the communication network 224). The user software application 320 may include, for example, a web browser capable of accessing a website and/or communicating signals and/or data over a wireless or wired network (e.g., the communication network 224) and/or the like.

The user database 324 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The user database 324 may be centralized or distributed across multiple systems.

The number of devices and/or networks illustrated in FIG. 3 is provided for explanatory purposes. In practice, there may be additional devices and/or networks, fewer devices and/or networks, different devices and/or networks, or differently arranged devices and/or networks than are shown in FIG. 3. Furthermore, two or more of the components or devices illustrated in FIG. 3 may be implemented within a single component or device, or a single component or device illustrated in FIG. 3 may be implemented as multiple, distributed components or devices. Additionally, or alternatively, one or more of the components or devices of the user device 216 may perform one or more functions described as being performed by another one or more of the components or devices of the user device 216. Components or devices of the user device 216 may interconnect via wired connections, wireless connections, or a combination thereof. For example, in one embodiment, the user device 216 and the network administrator device 220 may be integrated into the same device; that is, the user device 216 may perform functions and/or processes described as being performed by the network administrator device 220, described in more detail below.

Referring now to FIG. 4, shown therein is a block diagram of an exemplary embodiment of the network administrator device 220 of the transport network 200 constructed in accordance with the present disclosure. In some embodiments, the network administrator device 220 may include, but is not limited to, implementation as a personal computer, a cellular telephone, a smart phone, a network-capable television set, a tablet, a laptop computer, a desktop computer, a network-capable handheld device, a server, a digital video recorder, a wearable network-capable device, a VR/AR device, and/or the like.

As shown in FIG. 4, the network administrator device 220 generally includes one or more administrator input devices 400a-n (hereinafter, the “administrator input device 400”), one or more administrator output devices 404a-n (hereinafter, the “administrator output device 404”), one or more administrator processors 408a-n (hereinafter, the “administrator processor 408”), one or more administrator communication devices 412a-n (hereinafter, the “administrator communication device 412”), and one or more administrator memories 416a-n (hereinafter, the “administrator memory 416”) storing one or more administrator software applications 420a-n (hereinafter, the “administrator software application 420”) comprising processor-executable instructions and/or one or more administrator databases 424a-n (hereinafter, the “administrator database 424”). The administrator input device 400, the administrator output device 404, the administrator processor 408, the administrator communication device 412, and the administrator memory 416 may be connected via an administrator path 428 such as a data bus that permits communication among the components of the network administrator device 220.

The administrator input device 400 may be capable of receiving information input from the administrator processor 408 and/or the user 212, and transmitting such information to other components of the network administrator device 220 and/or the communication network 224. The administrator input device 400 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example.

The administrator output device 404 may be capable of outputting information in a form perceivable by the administrator processor 408 and/or the user 212. The administrator output device 404 may include, but is not limited to, implementation as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the administrator input device 400 and the administrator output device 404 may be implemented as a single device, such as, for example, a touchscreen of a computer, a tablet, or a smartphone. The administrator output device 404 may display the user interface on the network administrator device 220.

The administrator processor 408 may include, but is not limited to, implementation as a processor, a microprocessor, a mobile processor, an SoC, a CPU, an MCU, a DSP, an ASIC, an FPGA, a TPU, a GPU, a combination of hardware and software, and/or the like. The administrator processor 408 may be capable of communicating with the administrator input device 400, the administrator output device 404, the administrator communication device 412, and/or the administrator memory 416 via the administrator path 428. The administrator processor 408 may include one or more of the administrator processor 408 working together or independently and located locally or remotely (e.g., accessible via the communication network 224).

The administrator communication device 412, in communication with the administrator processor 408, may interface with the communication network 224. For example, the administrator processor 408 may be capable of communicating via the communication network 224 by exchanging signals (e.g., analog, digital, optical, and/or the like) via one or more ports (e.g., physical or virtual ports) using a network protocol to communicate signals and/or data with the user device 216 and/or the transport network 200.

The administrator memory 416 may comprise one or more non-transitory processor-readable media. The administrator memory 416 may store the administrator software application 420 that, when executed by the administrator processor 408, causes the network administrator device 220 to perform an action such as communicate with or control one or more component of the network administrator device 220 and/or, via the communication network 224, the transport network 200. The administrator memory 416 may include one or more of the administrator memory 416 working together or independently to store processor-executable code and may be located locally or remotely (e.g., accessible via the communication network 224). The administrator software application 420 may include, for example, a web browser capable of accessing a website and/or communicating signals and/or data over a wireless or wired network (e.g., the communication network 224) and/or the like.

The number of devices and/or networks illustrated in FIG. 4 is provided for explanatory purposes. In practice, there may be additional devices and/or networks, fewer devices and/or networks, different devices and/or networks, or differently arranged devices and/or networks than are shown in FIG. 4. Furthermore, two or more of the components or devices illustrated in FIG. 4 may be implemented within a single component or device, or a single component or device illustrated in FIG. 4 may be implemented as multiple, distributed components or devices. Additionally, or alternatively, one or more of the components or devices of the network administrator device 220 may perform one or more functions described as being performed by another one or more of the components or devices of the network administrator device 220. Components or devices of the network administrator device 220 may interconnect via wired connections, wireless connections, or a combination thereof. For example, in one embodiment, the network administrator device 220 and the user device 216 may be integrated into the same device; that is, the network administrator device 220 may perform functions and/or processes described as being performed by the user device 216, described above.

The administrator database 424 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The administrator database 424 may be centralized or distributed across multiple systems.

Referring now to FIG. 5, shown therein is a block diagram of an exemplary embodiment of the first network element 204a shown in FIG. 2. However, it should be understood that the description below may be applicable to any of the network elements 204 described herein. As shown in FIG. 5, the first network element 204a—and, therefore, any of the network elements 204 described herein—may comprise one or more of a transmitter 500 and a receiver 504 in addition to a controller 508.

The transmitter 500 is generally operable to receive outbound baseband signals (i.e., conducted electrical signals) having outbound client data encoded therein from a source external to the transmitter 500 (e.g., the controller 508), generate outbound radiated signals (i.e., radiated electromagnetic waves) based on the outbound baseband signals, and transmit and/or couple the outbound radiated signals into one of the hollow waveguides 208 (e.g., the first hollow waveguide 208a). As shown in FIG. 5, the transmitter 500 may comprise a client-side input 512 operable to receive the outbound baseband signals, transmitter circuitry 516 operable to receive the outbound baseband signals from the client-side input 512 and generate antenna feed signals based on the outbound baseband signals, and a transmitter antenna array 520 comprising one or more transmitter antennas and operable to receive the antenna feed signals from the transmitter circuitry 516, generate the outbound radiated signals based on the antenna feed signals, and transmit and/or couple the outbound radiated signals into one of the hollow waveguides 208 (e.g., the first hollow waveguide 208a).

The receiver 504 is generally operable to receive, detect, and/or decode inbound radiated signals from one of the hollow waveguides 208 (e.g., the first hollow waveguide 208a), generate inbound baseband signals based on the inbound radiated signals, and transmit the inbound baseband signals having inbound client data encoded therein to a destination external to the receiver 504 (e.g., the controller 508). As shown in FIG. 5, the receiver 504 may comprise a receiver antenna array 524 comprising one or more receiver antennas and operable to receive, detect, and/or decode the inbound radiated signals from one of the hollow waveguides 208 (e.g., the first hollow waveguide 208a) and generate antenna output signals based on the inbound radiated signals, receiver circuitry 528 operable to receive the antenna output signals from the receiver antenna array 524 and generate inbound baseband signals based on the antenna output signals, and a client-side output 532 operable to receive the inbound baseband signals from the receiver circuitry 528 and send the inbound baseband signals to a destination external to the receiver 504 (e.g., the controller 508).

The controller 508 is generally operable to regulate one or more operating parameters of the transmitter 500, the receiver 504, and/or the first network element 204a and/or send and/or receive signals and/or data to and/or from the transmitter 500 and/or the receiver 504.

Nonexclusive examples of how to make and use the transmitter 500 (including but not limited to the client-side input 512, the transmitter circuitry 516, and the transmitter antenna array 520), the receiver 504 (including but not limited to the receiver antenna array 524, the receiver circuitry 528, and the client-side output 532), and the hollow waveguide 208 are further described in U.S. patent application Ser. No. 18/927,535, titled “Fiber-Coupled Terahertz RF Transceiver System”, filed on Oct. 25, 2024, the entire contents of which are hereby incorporated herein by reference in their entirety.

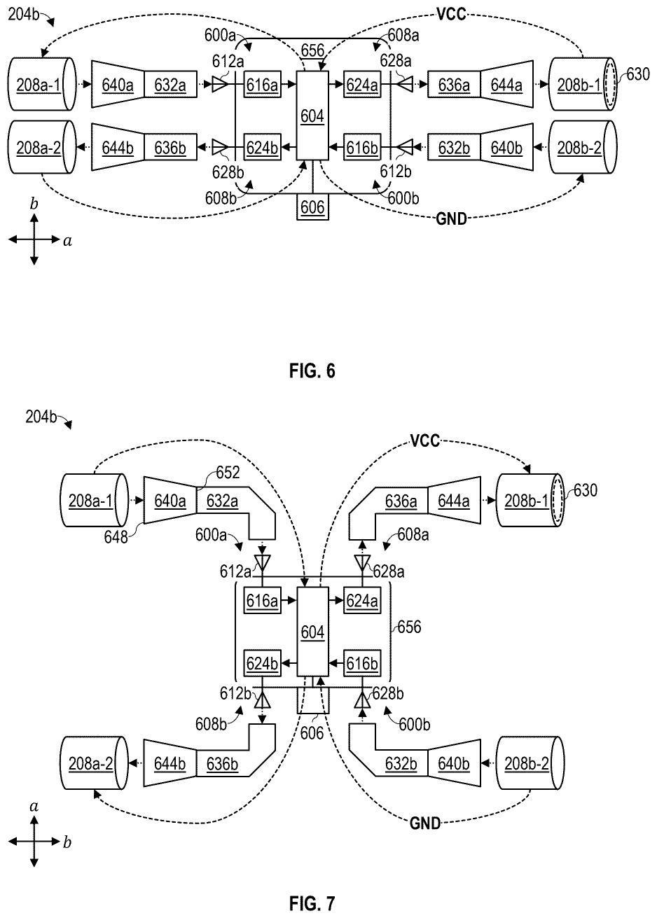

Referring now to FIGS. 6 and 7, shown therein are exemplary embodiments of the second network element 204b shown in FIG. 2. The second network element 204b may comprise one or more inbound electrical interfaces 600a-n (hereinafter, the “inbound electrical interfaces 600”) (e.g., a first inbound electrical interface 600a and a second inbound electrical interface 600b shown in FIGS. 6 and 7), a signal conditioning circuit 604, a control circuit 606, and one or more outbound electrical interfaces 608a-n (hereinafter, the “outbound electrical interfaces 608”) (e.g., a first outbound electrical interface 608a and a second outbound electrical interface 608b shown in FIGS. 6 and 7). The inbound electrical interfaces 600 may be constructed in a similar manner as the receiver antenna array 524. The control circuit 606 may be constructed in a similar manner as the controller 508. The outbound electrical interfaces 608 may be constructed in a similar manner as the transmitter antenna array 520. In some embodiments, the inbound electrical interfaces 600—including, in some such embodiments, the inbound antennas 612—, the signal conditioning circuit 604, and the outbound electrical interfaces 608—including, in some such embodiments, the outbound antennas 628—may be integrated together on a single semiconductor chip, such as an Indium phosphide (InP) semiconductor chip, for example.

In the embodiments shown in FIGS. 6 and 7, the second network element 204b is a bidirectional repeater. However, it should be understood that, in other embodiments, the second network element 204b may be a unidirectional repeater. That is, in such embodiments, the second network element 204b may comprise only one of the inbound electrical interfaces 600 and only one of the outbound electrical interfaces 608.

In some embodiments, the first hollow waveguide 208a and the second hollow waveguide 208b may be bidirectional; that is, the first hollow waveguide 208a may comprise a first inbound hollow waveguide 208a-1 configured to guide radiated electromagnetic waves toward the second network element 204b and a first outbound hollow waveguide 208a-2 configured to guide radiated electromagnetic waves away from the second network element 204b, while the second hollow waveguide 208b may comprise a second inbound hollow waveguide 208b-1 (the first inbound hollow waveguide 208a-1 and the second inbound hollow waveguide 208b-1, collectively, the “inbound hollow waveguides 208-1”) configured to guide radiated electromagnetic waves toward the second network element 204b and a second outbound hollow waveguide 208b-2 (the first outbound hollow waveguide 208a-2 and the second outbound hollow waveguide 208b-2, collectively, the “outbound hollow waveguides 208-2”) configured to guide radiated electromagnetic waves away from the second network element 204b.

The first inbound electrical interface 600a may comprise a first inbound waveguide 610a, a first inbound antenna 612a, and first inbound circuitry 616a. The first inbound antenna 612a may be configured to be coupled to the first inbound hollow waveguide 208a-1 and may be operable to receive a first inbound transmission signal from the first inbound hollow waveguide 208a-1 and generate a first antenna output signal based on the first inbound transmission signal. The first inbound circuitry 616a may be coupled to the first inbound antenna 612a and may be operable to receive the first antenna output signal from the first inbound antenna 612a and generate a first on-chip signal based on the first antenna output signal.

The second inbound electrical interface 600b may comprise a second inbound antenna 612b and second inbound circuitry 616b. The second inbound antenna 612b may be configured to be coupled to the second inbound hollow waveguide 208b-1 and may be operable to receive a second inbound transmission signal from the second inbound hollow waveguide 208b-1 and generate a second antenna output signal based on the inbound transmission signal. The second inbound circuitry 616b may be coupled to the second inbound antenna 612b and may be operable to receive the second antenna output signal from the second inbound antenna 612b and generate a second on-chip signal based on the second antenna output signal.

The first inbound transmission signal may be a first radiated electromagnetic wave coupled into the first inbound hollow waveguide 208a-1 and may be configured to have first client data encoded therein and a first inbound carrier frequency in a range from 300 GHz to 3 THz. Similarly, the second inbound transmission signal may be a second radiated electromagnetic wave coupled into the second inbound hollow waveguide 208b-1 and may be configured to have second client data encoded therein and a second inbound carrier frequency in the range from 300 GHz to 3 THz.

The signal conditioning circuit 604 may be coupled to the first inbound electrical interface 600a and the second inbound electrical interface 600b and may be operable to receive the first on-chip signal and the second on-chip signal from the first inbound electrical interface 600a and the second inbound electrical interface 600b, respectively, and modify the first on-chip signal and the second on-chip signal to generate a first modified on-chip signal based on the first on-chip signal and a second modified on-chip signal based on the second on-chip signal.

The first outbound electrical interface 608a may comprise first outbound circuitry 624a and a first outbound antenna 628a. The first outbound electrical interface 608a may be similar to the transmitter circuitry 516 and the transmitter antenna array 520 discussed above. The first outbound circuitry 624a may be coupled to the signal conditioning circuit 604 and may be operable to receive the first modified on-chip signal from the signal conditioning circuit 604 and generate a first antenna feed signal based on the first modified on-chip signal. The first outbound antenna 628a may be coupled to the first outbound circuitry 624a, may be configured to be coupled to the second outbound hollow waveguide 208b-2, and may be operable to receive the first antenna feed signal from the first outbound circuitry 624a, generate a first outbound transmission signal based on the first antenna feed signal, and couple the first outbound transmission signal into the second outbound hollow waveguide 208b-2.

The second outbound electrical interface 608b may comprise second outbound circuitry 624b and a second outbound antenna 628b. The second outbound electrical interface 608b may be similar to the transmitter circuitry 516 and the transmitter antenna array 520 discussed above. The second outbound circuitry 624b may be coupled to the signal conditioning circuit 604 and may be operable to receive the second modified on-chip signal from the signal conditioning circuit 604 and generate a second antenna feed signal based on the second modified on-chip signal. The second outbound antenna 628b may be coupled to the second outbound circuitry 624b, may be configured to be coupled to the first outbound hollow waveguide 208a-2, and may be operable to receive the second antenna feed signal from the second outbound circuitry 624b, generate a second outbound transmission signal based on the second antenna feed signal, and couple the second outbound transmission signal into the first outbound hollow waveguide 208a-2.

The first outbound transmission signal may be a third radiated electromagnetic wave coupled into the second outbound hollow waveguide 208b-2 and may be configured to have the first client data encoded therein and a first outbound carrier frequency in the range from 300 GHz to 3 THz. Similarly, the second outbound transmission signal may be a fourth radiated electromagnetic wave coupled into the first outbound hollow waveguide 208a-2 and may be configured to have the second client data encoded therein and a second outbound carrier frequency in the range from 300 GHz to 3 THz.

In some embodiments, at least one of the hollow waveguides 208 may have a conductive portion 630. For purposes of clarity, the conductive portion 630 of only the second outbound hollow waveguide 208b-2 is labeled with a reference character.

In some embodiments, the conductive portion 630 of one or more of the inbound hollow waveguides 208-1 may be operable to provide a power supply voltage, and one or more of the inbound electrical interfaces 600 may be operable to receive the power supply voltage from the conductive portion 630 of the one or more of the inbound hollow waveguides 208-1. In some such embodiments, the signal conditioning circuit 604 may be operable to receive the power supply voltage from the one or more of the inbound electrical interfaces 600. In other embodiments, a first conductive wire (not shown) that is separate from the hollow waveguides 208 may be operable to provide the power supply voltage, and the one or more of the inbound electrical interfaces 600 may be operable to receive the power supply voltage from the first conductive wire.

In some embodiments, the conductive portion 630 of one or more of the outbound hollow waveguides 208-2 may be operable to provide a reference ground potential, and one or more of the outbound electrical interfaces 608 may be operable to receive the reference ground potential from the conductive portion 630 of the one or more of the outbound hollow waveguides 208-2. In some such embodiments, the signal conditioning circuit 604 may be operable to receive the reference ground potential from the one or more of the outbound electrical interfaces 608. In other embodiments, a second conductive wire (not shown) that is separate from the hollow waveguides 208 may be operable to provide the reference ground potential, and the one or more of the outbound electrical interfaces 608 may be operable to receive the reference ground potential from the second conductive wire.

It should be understood that while the conductive portion 630 of one or more of the inbound hollow waveguides 208-1 and one or more of the outbound hollow waveguides 208-2 are described as providing the power supply voltage and the reference ground potential, respectively, the conductive portion 630 of either of the one or more of the inbound hollow waveguides 208-1 and the one or more of the outbound hollow waveguides 208-2 may provide the power supply voltage and the conductive portion 630 of either of the one or more of the inbound hollow waveguides 208-1 and the one or more of the outbound hollow waveguides 208-2 may provide the reference ground potential.

Similarly, while the inbound electrical interfaces 600 and the outbound electrical interfaces 608 are described above as receiving the power supply voltage and the reference ground potential, respectively, either of the inbound electrical interfaces 600 and the outbound electrical interfaces 608 may receive the power supply voltage and either of the inbound electrical interfaces 600 and the outbound electrical interfaces 608 may receive the reference ground potential.

In some embodiments, one or more of the inbound electrical interfaces 600 and the outbound electrical interfaces 608 may be operable to receive a control signal from the conductive portion 630 of one or more of the inbound hollow waveguides 208-1 and the outbound hollow waveguides 208-2, respectively. In such embodiments, the control circuit 606 may be operable to receive the control signal from one or more of the inbound electrical interfaces 600 and the outbound electrical interfaces 608. In response to receiving the control signal, the control circuit 606 may be operable to adjust one or more operating parameters of the second network element 204b based on the control signal.

In some embodiments, one or more of the inbound electrical interfaces 600 may further comprise a particular one of one or more inbound waveguides 632a-n (hereinafter, the “inbound waveguides 632”) (e.g., a first inbound waveguide 632a and a second inbound waveguide 632b shown in FIGS. 6 and 7). In some such embodiments, one or more of the inbound electrical interfaces 600 may further comprise a particular one of one or more inbound tapered waveguides 640a-n (hereinafter, the “inbound tapered waveguides 640”) (e.g., a first inbound tapered waveguide 640a and a second inbound tapered waveguide 640b shown in FIGS. 6 and 7).

In some embodiments, one or more of the outbound electrical interfaces 608 may further comprise a particular one of one or more outbound waveguides 636a-n (hereinafter, the “outbound waveguides 636”) (e.g., a first outbound waveguide 636a and a second outbound waveguide 636b shown in FIGS. 6 and 7). In some such embodiments, one or more of the outbound electrical interfaces 608 may further comprise a particular one of one or more outbound tapered waveguides 644a-n (hereinafter, the “outbound tapered waveguides 644”) (e.g., a first outbound tapered waveguide 644a and a second outbound tapered waveguide 644b shown in FIGS. 6 and 7).

Each of the tapered waveguides (i.e., the inbound tapered waveguides 640 and the outbound tapered waveguides 644) may have a first taper end 648 and a second taper end 652. The first taper end 648 of each of the tapered waveguides 640, 644 may be configured to be coupled to one of the hollow waveguides 208 and may have a first effective mode area. The second taper end 652 of each of the tapered waveguides 640, 644 may be configured to be coupled to one of the antennas (i.e., the inbound antennas 612 and the outbound antennas 628) and may have a second effective mode area that is smaller than the first effective mode area. For purposes of clarity, the first taper end 648 and the second taper end 652 of only the first inbound tapered waveguide 640a are labeled with a reference character.

In some embodiments, the second network element 204b may further comprise a substrate 656 having a planar surface on which the signal conditioning circuit 604 is disposed. In such embodiments, at least one of the inbound antennas 612 and the outbound antennas 628 may have a major axis a and a minor axis b. In some such embodiments, such as is shown in FIG. 6, the major axis a may extend coplanar with the planar surface of the substrate 656. In other such embodiments, such as is shown in FIG. 7, the major axis a may extend orthogonal to the planar surface of the substrate 656.

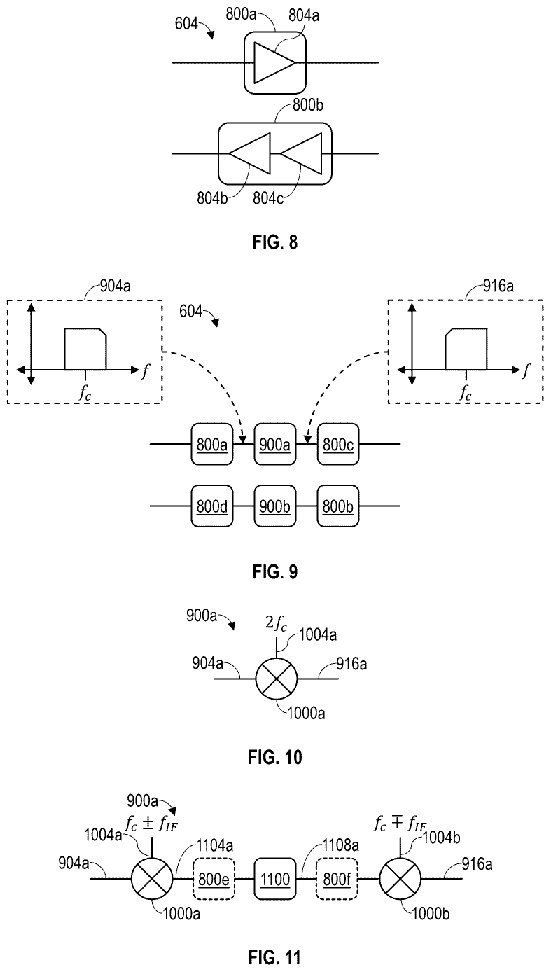

Referring now to FIG. 8, shown therein is an exemplary embodiment of the signal conditioning circuit 604 constructed in accordance with the present disclosure. In the embodiment shown in FIG. 8, the signal conditioning circuit 604 may comprise one or more gain block amplifiers (hereinafter, the “gain block amplifiers 800”) (e.g., a first gain block amplifier 800a and a second gain block amplifier 800b shown in FIG. 8). The first gain block amplifier 800a may be coupled to the first inbound electrical interface 600a and may be operable to receive the first on-chip signal from the first inbound electrical interface 600a and amplify the first on-chip signal to generate the first modified on-chip signal based on the first on-chip signal. Similarly, the second gain block amplifier 800b may be coupled to the second inbound electrical interface 600b and may be operable to receive the second on-chip signal from the second inbound electrical interface 600b and amplify the second on-chip signal to generate the second modified on-chip signal based on the second on-chip signal.

In some embodiments, one or more of the gain block amplifiers 800—such as the first gain block amplifier 800a shown in FIG. 8—may comprise a single gain stage 804a, while one or more of the gain block amplifiers 800—such as the second gain block amplifier 800b shown in FIG. 8—may comprise a plurality of gain stages 804b-n (collectively, the “gain stages 804”) (e.g., a second gain stage 804b and a third gain stage 804c shown in FIG. 8). As shown by the second gain block amplifier 800b shown in FIG. 8, the gain stages 804 may be concatenated (i.e., connected in series). While the second gain block amplifier 800b is shown in FIG. 8 as comprising two of the gain stages 804, it should be understood that one or more of the gain block amplifiers 800 may comprise a number of the gain stages 804 that is greater or fewer than two.

Referring now to FIG. 9, shown therein is another exemplary embodiment of the signal conditioning circuit 604 constructed in accordance with the present disclosure. In the embodiment shown in FIG. 9, the signal conditioning circuit 604 may comprise the gain block amplifiers 800 (e.g., the first gain block amplifier 800a, the second gain block amplifier 800b, a third gain block amplifier 800c, and a fourth gain block amplifier 800d shown in FIG. 8), as well as one or more spectrum mirroring and/or phase conjugating circuits 900a-n (hereinafter, the “spectrum mirroring circuits 900”) (e.g., a first spectrum mirroring circuit 900a and a second spectrum mirroring circuit 900b shown in FIG. 9). Each of the gain block amplifiers 800 shown in FIG. 9 may be constructed in a similar manner as either of the gain block amplifiers 800 shown in FIG. 8.

It should be understood that one or more of the signals described herein, such as a first on-chip signal 904a being transmitted from the first gain block amplifier 800a to the first spectrum mirroring circuit 900a and a second on-chip signal (not shown) being transmitted from the second gain block amplifier to the second spectrum mirroring circuit 900b, may have a plurality of frequencies ƒ including a center frequency ƒ_{c}.

One or more of the spectrum mirroring circuits 900 may be operable to receive a particular one of the on-chip signals (e.g., the first on-chip signal 904a) and mirror the frequencies ƒ of the particular one of the on-chip signals about the center frequency ƒ_{c}, thereby generating a particular one of one or more mirrored on-chip signals (e.g., a first mirrored on-chip signal 916a). For purposes of clarity, only the first on-chip signal 904a and the first mirrored on-chip signal 916a of the one or more on-chip signals are labeled with reference characters.

Referring now to FIG. 10, shown therein is an exemplary embodiment of the first spectrum mirroring circuit 900a constructed in accordance with the present disclosure. In the embodiment shown in FIG. 10, the first spectrum mirroring circuit 900a may comprise a first frequency mixer 1000a operable to mix the on-chip signal (e.g., the first on-chip signal 904a) with a local oscillator (LO) signal (e.g., a first LO signal 1004a shown in FIG. 10) having an LO frequency that is double the center frequency of the on-chip signal (2ƒ_{c}).

Referring now to FIG. 11, shown therein is another exemplary embodiment of the first spectrum mirroring circuit 900a constructed in accordance with the present disclosure. In the embodiment shown in FIG. 11, the first spectrum mirroring circuit may comprise the first frequency mixer 1000a, a second frequency mixer 1000b, and a low-pass filter 1100. In some embodiments, the first spectrum mirroring circuit 900a may further comprise one or more of the gain block amplifiers 800 (e.g., a fifth gain block amplifier 800e and a sixth gain block amplifier 800f shown in FIG. 11) coupled to the low-pass filter 1100. As shown in FIG. 11, the gain block amplifiers 800 may be positioned before the low-pass filter 1100 (such as the fifth gain block amplifier 800e), after the low-pass filter 1100 (such as the sixth gain block amplifier 800f), or both before and after the low-pass filter 1100.

The first frequency mixer 1000a may be operable to receive the on-chip signal (e.g., the first on-chip signal 904a) and mix the on-chip signal with the first LO signal 1004a having a first LO frequency that is equal to the center frequency (ƒ_{c}) plus or minus an on-chip frequency (i.e., an intermediate frequency) (ƒ_{IF})(ƒ_{c}±ƒ_{IF}) to generate an intermediate signal (e.g., a first intermediate signal 1104a shown in FIG. 11). The low-pass filter 1100 may be operable to receive the intermediate signal and attenuate at least one of the frequencies of the intermediate signal above a predetermined cutoff frequency to generate a filtered intermediate signal (e.g., a first filtered intermediate signal 1108a shown in FIG. 11). The second frequency mixer 1000b may be operable to receive the filtered intermediate signal and mix the filtered intermediate signal with a second LO signal 1004b having a second LO frequency that is equal to the center frequency (ƒ_{c}) minus or plus the on-chip frequency (i.e., the intermediate frequency) (ƒ_{IF})(ƒ_{c}∓ƒ_{IF}) to generate the mirrored on-chip signal (e.g., the first mirrored on-chip signal 916a).

When mixing the on-chip signal (e.g., the first on-chip signal 904a) having the center frequency (ƒ_{c}) with the first LO signal 1004a having the first LO frequency (ƒ_{c}±ƒ_{IF}), the intermediate signal (e.g., the first intermediate signal 1104a) may be generated comprising a lower sideband centered at the on-chip frequency (i.e., the intermediate frequency) (ƒ_{IF}) and an upper sideband centered at double the center frequency plus or minus the intermediate frequency (2ƒ_{c}±ƒ_{IF}). As referenced above, in order to remove this upper sideband, the low-pass filter 1100 may be operable to attenuate at least one of the frequencies of the intermediate signal above a predetermined cutoff frequency, thereby generating the filtered intermediate signal (e.g., the first filtered intermediate signal 1108a). For an on-chip signal having a particular bandwidth B, the predetermined cutoff frequency may be in a range between a minimum cutoff frequency ƒ_{IF}+B/2, and a maximum cutoff frequency 2ƒ_{c}−ƒ_{IF}−B/2). In some embodiments, the low-pass filter 1100 may comprise an active circuit configured to provide gain to signals within the passband of the low-pass filter 1100.

### ILLUSTRATIVE CLAUSES

Exemplary, non-limiting illustrative clauses are provided in the clauses below. However, the scope of the present inventive concept(s) is to be understood to not be limited in any manner by the clauses presented below.

### Illustrative Clause 1

A network element, comprising: an inbound electrical interface comprising an inbound antenna configured to be coupled to an inbound Terahertz (THz) waveguide and operable to receive an inbound transmission signal from the inbound THz waveguide and generate an antenna output signal based on the inbound transmission signal, the inbound transmission signal being a radiated electromagnetic wave coupled into the inbound THz waveguide and configured to have client data encoded therein and an inbound carrier frequency in a range from 300 Gigahertz (GHz) to 3 THz, the inbound electrical interface further comprising inbound circuitry coupled to the inbound antenna and operable to receive the antenna output signal from the inbound antenna and generate an on-chip signal based on the antenna output signal; a signal conditioning circuit operable to receive the on-chip signal from the inbound electrical interface and modify the on-chip signal to generate a modified on-chip signal based on the on-chip signal; and an outbound electrical interface comprising an outbound antenna configured to be coupled to an outbound THz waveguide, the outbound electrical interface further comprising outbound circuitry coupled to the outbound antenna and operable to receive the modified on-chip signal from the signal conditioning circuit and generate an antenna feed signal based on the modified on-chip signal, the outbound antenna being operable to receive the antenna feed signal from the outbound circuitry, generate an outbound transmission signal based on the antenna feed signal, and couple the outbound transmission signal into the outbound THz waveguide, the outbound transmission signal being a radiated electromagnetic wave configured to have the client data encoded therein and an outbound carrier frequency in the range from 300 GHz to 3 THz.

### Illustrative Clause 2

The network element of illustrative clause 1, further comprising the inbound THz waveguide coupled to the inbound antenna and the outbound THz waveguide coupled to the outbound antenna, the inbound THz waveguide having a first conductive portion operable to provide a power supply voltage and the outbound THz waveguide having a second conductive portion connected to a reference ground potential, the inbound electrical interface being operable to receive the power supply voltage from the first conductive portion of the inbound THz waveguide, the outbound electrical interface being operable to receive the reference ground potential from the second conductive portion of the outbound THz waveguide, the signal conditioning circuit being operable to receive the power supply voltage from the inbound electrical interface and the reference ground potential from the outbound electrical interface.

### Illustrative Clause 3

The network element of illustrative clause 2, further comprising a control circuit, a particular conductive portion of the first conductive portion of the inbound THz waveguide and the second conductive portion of the outbound THz waveguide being further operable to provide a control signal, a particular electrical interface of the inbound electrical interface and the outbound electrical interface being further operable to receive the control signal from the particular conductive portion, the control circuit being operable to receive the control signal from the particular electrical interface and adjust an operating parameter of the network element based on the control signal.

### Illustrative Clause 4

The network element of illustrative clause 1, wherein the signal conditioning circuit comprises one or more amplifiers operable to amplify the on-chip signal to generate the modified on-chip signal.

### Illustrative Clause 5

The network element of illustrative clause 4, wherein the on-chip signal has a plurality of frequencies including a center frequency, the signal conditioning circuit further comprising a spectrum mirroring circuit operable to mirror the plurality of frequencies of the on-chip signal about the center frequency to generate a mirrored on-chip signal based on the on-chip signal.

### Illustrative Clause 6

The network element of illustrative clause 5, wherein the spectrum mirroring circuit comprises a mixer operable to mix the on-chip signal with a local oscillator (LO) signal having an LO frequency double the center frequency.

### Illustrative Clause 7

The network element of illustrative clause 5, wherein the spectrum mirroring circuit comprises a first mixer, a low-pass filter, and a second mixer, the first mixer being operable to mix the on-chip signal with a first local oscillator (LO) signal having a first LO frequency equal to the center frequency plus or minus an on-chip frequency to generate an intermediate signal based on the on-chip signal and the LO signal, the low-pass filter operable to attenuate at least one of the plurality of frequencies of the intermediate signal above a cutoff frequency to generate a filtered intermediate signal based on the intermediate signal, the second mixer being operable to mix the filtered intermediate signal with a second LO signal having a second LO frequency equal to the center frequency minus or plus the on-chip frequency to generate the mirrored on-chip signal.

### Illustrative Clause 8

The network element of illustrative clause 1, wherein at least one of the inbound electrical interface and the outbound electrical interface further comprises a tapered waveguide having a first taper end and a second taper end, the first taper end being configured to be coupled to one of the inbound THz waveguide and the outbound THz waveguide and having a first effective mode area, the second taper end being configured to be coupled to one of the inbound antenna and the outbound antenna and having a second effective mode area smaller than the first effective mode area.

### Illustrative Clause 9

The network element of illustrative clause 1, further comprising a substrate having a planar surface on which the signal conditioning circuit is disposed, at least one of the inbound antenna and the outbound antenna having a major axis and a minor axis, the major axis extending orthogonal to the planar surface of the substrate.

### Illustrative Clause 10

The network element of illustrative clause 1, further comprising a substrate having a planar surface on which the signal conditioning circuit is disposed, at least one of the inbound antenna and the outbound antenna having a major axis and a minor axis, the major axis extending coplanar with the planar surface of the substrate.

### Illustrative Clause 11

A network element, comprising: a first inbound electrical interface comprising a first inbound antenna configured to be coupled to a first inbound Terahertz (THz) waveguide and operable to receive a first inbound transmission signal from the first inbound THz waveguide and generate a first antenna output signal based on the first inbound transmission signal, the first inbound electrical interface further comprising first inbound circuitry coupled to the first inbound antenna and operable to receive the first antenna output signal from the first inbound antenna and generate a first on-chip signal based on the first antenna output signal, the first inbound transmission signal being a radiated electromagnetic wave coupled into the first inbound THz waveguide and configured to have first client data encoded therein and a first inbound carrier frequency in a range from 300 Gigahertz (GHz) to 3 THz; a second inbound electrical interface comprising a second inbound antenna configured to be coupled to a second inbound THz waveguide and operable to receive a second inbound transmission signal from the second inbound THz waveguide and generate a second antenna output signal based on the second inbound transmission signal, the second inbound electrical interface further comprising second inbound circuitry coupled to the second inbound antenna and operable to receive the second antenna output signal from the second inbound antenna and generate a second on-chip signal based on the second antenna output signal, the second inbound transmission signal being a radiated electromagnetic wave coupled into the second inbound THz waveguide and configured to have second client data encoded therein and a second inbound carrier frequency in the range from 300 GHz to 3 THz; a signal conditioning circuit operable to receive the first on-chip signal from the first inbound electrical interface and the second on-chip signal from the second inbound electrical interface and modify the first on-chip signal to generate a first modified on-chip signal based on the first on-chip signal and the second on-chip signal to generate a second modified on-chip signal based on the second on-chip signal; a first outbound electrical interface comprising a first outbound antenna configured to be coupled to a first outbound THz waveguide, the first outbound electrical interface further comprising first outbound circuitry coupled to the first outbound antenna and operable to receive the first modified on-chip signal from the signal conditioning circuit and generate a first antenna feed signal based on the first modified on-chip signal, the first outbound antenna being operable to receive the first antenna feed signal from the first outbound circuitry, generate a first outbound transmission signal based on the first antenna feed signal, and couple the first outbound transmission signal into the first outbound THz waveguide, the first outbound transmission signal being a radiated electromagnetic wave configured to have a first outbound carrier frequency in the range from 300 GHz to 3 THz; and a second outbound electrical interface comprising a second outbound antenna configured to be coupled to a second outbound THz waveguide, the second outbound electrical interface further comprising second outbound circuitry coupled to the second outbound antenna and operable to receive the second modified on-chip signal from the signal conditioning circuit and generate a second antenna feed signal based on the second modified on-chip signal, the second outbound antenna being operable to receive the second antenna feed signal from the second outbound circuitry, generate a second outbound transmission signal based on the second antenna feed signal, and couple the second outbound transmission signal into the second outbound THz waveguide, the second outbound transmission signal being a radiated electromagnetic wave configured to have a second outbound carrier frequency in the range from 300 GHz to 3 THz.

### Illustrative Clause 12

The network element of illustrative clause 11, further comprising a particular inbound THz waveguide of the first inbound THz waveguide and the second inbound THz waveguide and a particular outbound THz waveguide of the first outbound THz waveguide and the second outbound THz waveguide, the particular inbound THz waveguide being coupled to a particular inbound antenna of the first inbound antenna and the second inbound antenna, the particular outbound THz waveguide being coupled to a particular outbound antenna of the first outbound antenna and the second outbound antenna, the particular inbound THz waveguide having a first conductive portion operable to provide a power supply voltage, the particular outbound THz waveguide having a second conductive portion connected to a reference ground potential, a particular inbound electrical interface of the first inbound electrical interface and the second inbound electrical interface being operable to receive the power supply voltage from the first conductive portion of the particular inbound THz waveguide, a particular outbound electrical interface of the first outbound electrical interface and the second outbound electrical interface being operable to receive the reference ground potential from the second conductive portion of the particular outbound THz waveguide, the signal conditioning circuit being operable to receive the power supply voltage from the particular inbound electrical interface and the reference ground potential from the particular outbound electrical interface.

### Illustrative Clause 13

The network element of illustrative clause 12, further comprising a control circuit, a particular conductive portion of the first conductive portion of the particular inbound THz waveguide and the second conductive portion of the particular outbound THz waveguide being further operable to provide a control signal, a particular electrical interface of the particular inbound electrical interface and the particular outbound electrical interface being further operable to receive the control signal from the particular conductive portion, the control circuit being operable to receive the control signal from the particular electrical interface and adjust an operating parameter of the network element based on the control signal.

### Illustrative Clause 14

The network element of illustrative clause 11, wherein the signal conditioning circuit comprises one or more first amplifiers operable to amplify the first on-chip signal to generate the first modified on-chip signal and one or more second amplifiers operable to amplify the second on-chip signal to generate the second modified on-chip signal.

### Illustrative Clause 15

The network element of illustrative clause 14, wherein the first on-chip signal has a plurality of first frequencies including a first center frequency and the second on-chip signal has a plurality of second frequencies including a second center frequency, the signal conditioning circuit further comprising a first spectrum mirroring circuit operable to mirror the plurality of first frequencies of the first on-chip signal about the first center frequency to generate a first mirrored on-chip signal based on the first on-chip signal and a second spectrum mirroring circuit operable to mirror the plurality of second frequencies of the second on-chip signal about the second center frequency to generate a second mirrored on-chip signal based on the second on-chip signal.

### Illustrative Clause 16

The network element of illustrative clause 15, wherein the first spectrum mirroring circuit comprises a first mixer operable to mix the first on-chip signal with a first local oscillator (LO) signal having a first LO frequency double the first center frequency and the second spectrum mirroring circuit comprises a second mixer operable to mix the second on-chip signal with a second LO signal having a second LO frequency double the second center frequency.

### Illustrative Clause 17

The network element of illustrative clause 15, wherein the first spectrum mirroring circuit comprises a first mixer, a first low-pass filter, and a second mixer, and the second spectrum mirroring circuit comprises a third mixer, a second low-pass filter, and a fourth mixer, wherein: the first mixer is operable to mix the first on-chip signal with a first local oscillator (LO) signal having a first LO frequency equal to the first center frequency plus or minus a first on-chip frequency to generate a first intermediate signal based on the first on-chip signal and the first LO signal, the first low-pass filter being operable to attenuate at least one of the plurality of first frequencies of the first intermediate signal above a first cutoff frequency to generate a first filtered intermediate signal based on the intermediate signal, the second mixer being operable to mix the first filtered intermediate signal with a second LO signal having a second LO frequency equal to the first center frequency minus or plus the first on-chip frequency to generate the first mirrored on-chip signal; and the third mixer is operable to mix the second on-chip signal with a third LO signal having a third LO frequency equal to the second center frequency plus or minus a second on-chip frequency to generate a second intermediate signal based on the second on-chip signal and the second LO signal, the second low-pass filter being operable to attenuate at least one of the plurality of second frequencies of the second intermediate signal above a second cutoff frequency to generate a second filtered intermediate signal based on the intermediate signal, the fourth mixer being operable to mix the second filtered intermediate signal with a fourth LO signal having a fourth LO frequency equal to the second center frequency minus or plus the second on-chip frequency to generate the second mirrored on-chip signal.

### Illustrative Clause 18

The network element of illustrative clause 11, wherein the at least one of the first inbound electrical interface, the second inbound electrical interface, the first outbound electrical interface, and the second outbound electrical interface further comprises a tapered waveguide having a first taper end and a second taper end, the first taper end being configured to be coupled to one of the first inbound THz waveguide, the second inbound THz waveguide, the first outbound THz waveguide, and the second outbound THz waveguide and having a first effective mode area, the second taper end being configured to be coupled to at least one of the first inbound antenna, the second inbound antenna, the first outbound antenna, and the second outbound antenna and having a second effective mode area smaller than the first effective mode area.

### Illustrative Clause 19

The network element of illustrative clause 11, further comprising a substrate having a planar surface on which the signal conditioning circuit is disposed, at least one of the first inbound antenna, the second inbound antenna, the first outbound antenna, and the second outbound antenna having a major axis and a minor axis, the major axis extending orthogonal to the planar surface of the substrate.

### Illustrative Clause 20

The network element of illustrative clause 11, further comprising a substrate having a planar surface on which the signal conditioning circuit is disposed, at least one of the first inbound antenna, the second inbound antenna, the first outbound antenna, and the second outbound antenna having a major axis and a minor axis, the major axis extending coplanar with the planar surface of the substrate.

### Conclusion

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

1. A network element, comprising:
an inbound electrical interface comprising an inbound antenna configured to be coupled to an inbound Terahertz (THz) waveguide and operable to receive an inbound transmission signal from the inbound THz waveguide and generate an antenna output signal based on the inbound transmission signal, the inbound transmission signal being a radiated electromagnetic wave coupled into the inbound THz waveguide and configured to have client data encoded therein and an inbound carrier frequency in a range from 100 Gigahertz (GHz) to 10 THz, the inbound electrical interface further comprising inbound circuitry coupled to the inbound antenna and operable to receive the antenna output signal from the inbound antenna and generate an on-chip signal based on the antenna output signal;
a signal conditioning circuit operable to receive the on-chip signal from the inbound electrical interface and modify the on-chip signal to generate a modified on-chip signal based on the on-chip signal; and
an outbound electrical interface comprising an outbound antenna configured to be coupled to an outbound THz waveguide, the outbound electrical interface further comprising outbound circuitry coupled to the outbound antenna and operable to receive the modified on-chip signal from the signal conditioning circuit and generate an antenna feed signal based on the modified on-chip signal, the outbound antenna being operable to receive the antenna feed signal from the outbound circuitry, generate an outbound transmission signal based on the antenna feed signal, and couple the outbound transmission signal into the outbound THz waveguide, the outbound transmission signal being a radiated electromagnetic wave configured to have the client data encoded therein and an outbound carrier frequency in the range from 100 GHz to 10 THz.

2. The network element of claim 1, further comprising the inbound THz waveguide coupled to the inbound antenna and the outbound THz waveguide coupled to the outbound antenna, the inbound THz waveguide having a first conductive portion operable to provide a power supply voltage and the outbound THz waveguide having a second conductive portion connected to a reference ground potential, the inbound electrical interface being operable to receive the power supply voltage from the first conductive portion of the inbound THz waveguide, the outbound electrical interface being operable to receive the reference ground potential from the second conductive portion of the outbound THz waveguide, the signal conditioning circuit being operable to receive the power supply voltage from the inbound electrical interface and the reference ground potential from the outbound electrical interface.

3. The network element of claim 2, further comprising a control circuit, a particular conductive portion of the first conductive portion of the inbound THz waveguide and the second conductive portion of the outbound THz waveguide being further operable to provide a control signal, a particular electrical interface of the inbound electrical interface and the outbound electrical interface being further operable to receive the control signal from the particular conductive portion, the control circuit being operable to receive the control signal from the particular electrical interface and adjust an operating parameter of the network element based on the control signal.

4. The network element of claim 1, wherein the signal conditioning circuit comprises one or more amplifiers operable to amplify the on-chip signal to generate the modified on-chip signal.

5. The network element of claim 4, wherein the on-chip signal has a plurality of frequencies including a center frequency, the signal conditioning circuit further comprising a spectrum mirroring circuit operable to mirror the plurality of frequencies of the on-chip signal about the center frequency to generate a mirrored on-chip signal.

6. The network element of claim 5, wherein the spectrum mirroring circuit comprises a mixer operable to mix the on-chip signal with a local oscillator (LO) signal having an LO frequency double the center frequency.

7. The network element of claim 5, wherein the spectrum mirroring circuit comprises a first mixer, a low-pass filter, and a second mixer, the first mixer being operable to mix the on-chip signal with a first local oscillator (LO) signal having a first LO frequency equal to the center frequency plus or minus an on-chip frequency to generate an intermediate signal based on the on-chip signal and the LO signal, the low-pass filter operable to attenuate at least one of the plurality of frequencies of the intermediate signal above a cutoff frequency to generate a filtered intermediate signal based on the intermediate signal, the second mixer being operable to mix the filtered intermediate signal with a second LO signal having a second LO frequency equal to the center frequency minus or plus the on-chip frequency to generate the mirrored on-chip signal.

8. The network element of claim 1, wherein at least one of the inbound electrical interface and the outbound electrical interface further comprises a tapered waveguide having a first taper end and a second taper end, the first taper end being configured to be coupled to one of the inbound THz waveguide and the outbound THz waveguide and having a first effective mode area, the second taper end being configured to be coupled to one of the inbound antenna and the outbound antenna and having a second effective mode area smaller than the first effective mode area.

9. The network element of claim 1, further comprising a substrate having a planar surface on which the signal conditioning circuit is disposed, at least one of the inbound antenna and the outbound antenna having a major axis and a minor axis, the major axis extending orthogonal to the planar surface of the substrate.

10. The network element of claim 1, further comprising a substrate having a planar surface on which the signal conditioning circuit is disposed, at least one of the inbound antenna and the outbound antenna having a major axis and a minor axis, the major axis extending coplanar with the planar surface of the substrate.

11. A network element, comprising:
a first inbound electrical interface comprising a first inbound antenna configured to be coupled to a first inbound Terahertz (THz) waveguide and operable to receive a first inbound transmission signal from the first inbound THz waveguide and generate a first antenna output signal based on the first inbound transmission signal, the first inbound electrical interface further comprising first inbound circuitry coupled to the first inbound antenna and operable to receive the first antenna output signal from the first inbound antenna and generate a first on-chip signal based on the first antenna output signal, the first inbound transmission signal being a radiated electromagnetic wave coupled into the first inbound THz waveguide and configured to have first client data encoded therein and a first inbound carrier frequency in a range from 100 Gigahertz (GHz) to 10 THz;
a second inbound electrical interface comprising a second inbound antenna configured to be coupled to a second inbound THz waveguide and operable to receive a second inbound transmission signal from the second inbound THz waveguide and generate a second antenna output signal based on the second inbound transmission signal, the second inbound electrical interface further comprising second inbound circuitry coupled to the second inbound antenna and operable to receive the second antenna output signal from the second inbound antenna and generate a second on-chip signal based on the second antenna output signal, the second inbound transmission signal being a radiated electromagnetic wave coupled into the second inbound THz waveguide and configured to have second client data encoded therein and a second inbound carrier frequency in the range from 100 GHz to 10 THz;
a signal conditioning circuit operable to receive the first on-chip signal from the first inbound electrical interface and the second on-chip signal from the second inbound electrical interface and modify the first on-chip signal to generate a first modified on-chip signal based on the first on-chip signal and the second on-chip signal to generate a second modified on-chip signal based on the second on-chip signal;
a first outbound electrical interface comprising a first outbound antenna configured to be coupled to a first outbound THz waveguide, the first outbound electrical interface further comprising first outbound circuitry coupled to the first outbound antenna and operable to receive the first modified on-chip signal from the signal conditioning circuit and generate a first antenna feed signal based on the first modified on-chip signal, the first outbound antenna being operable to receive the first antenna feed signal from the first outbound circuitry, generate a first outbound transmission signal based on the first antenna feed signal, and couple the first outbound transmission signal into the first outbound THz waveguide, the first outbound transmission signal being a radiated electromagnetic wave configured to have a first outbound carrier frequency in the range from 100 GHz to 10 THz; and
a second outbound electrical interface comprising a second outbound antenna configured to be coupled to a second outbound THz waveguide, the second outbound electrical interface further comprising second outbound circuitry coupled to the second outbound antenna and operable to receive the second modified on-chip signal from the signal conditioning circuit and generate a second antenna feed signal based on the second modified on-chip signal, the second outbound antenna being operable to receive the second antenna feed signal from the second outbound circuitry, generate a second outbound transmission signal based on the second antenna feed signal, and couple the second outbound transmission signal into the second outbound THz waveguide, the second outbound transmission signal being a radiated electromagnetic wave configured to have a second outbound carrier frequency in the range from 100 GHz to 10 THz.

12. The network element of claim 11, further comprising a particular inbound THz waveguide of the first inbound THz waveguide and the second inbound THz waveguide and a particular outbound THz waveguide of the first outbound THz waveguide and the second outbound THz waveguide, the particular inbound THz waveguide being coupled to a particular inbound antenna of the first inbound antenna and the second inbound antenna, the particular outbound THz waveguide being coupled to a particular outbound antenna of the first outbound antenna and the second outbound antenna, the particular inbound THz waveguide having a first conductive portion operable to provide a power supply voltage, the particular outbound THz waveguide having a second conductive portion connected to a reference ground potential, a particular inbound electrical interface of the first inbound electrical interface and the second inbound electrical interface being operable to receive the power supply voltage from the first conductive portion of the particular inbound THz waveguide, a particular outbound electrical interface of the first outbound electrical interface and the second outbound electrical interface being operable to receive the reference ground potential from the second conductive portion of the particular outbound THz waveguide, the signal conditioning circuit being operable to receive the power supply voltage from the particular inbound electrical interface and the reference ground potential from the particular outbound electrical interface.

13. The network element of claim 12, further comprising a control circuit, a particular conductive portion of the first conductive portion of the particular inbound THz waveguide and the second conductive portion of the particular outbound THz waveguide being further operable to provide a control signal, a particular electrical interface of the particular inbound electrical interface and the particular outbound electrical interface being further operable to receive the control signal from the particular conductive portion, the control circuit being operable to receive the control signal from the particular electrical interface and adjust an operating parameter of the network element based on the control signal.

14. The network element of claim 11, wherein the signal conditioning circuit comprises one or more first amplifiers operable to amplify the first on-chip signal to generate the first modified on-chip signal and one or more second amplifiers operable to amplify the second on-chip signal to generate the second modified on-chip signal.

15. The network element of claim 14, wherein the first on-chip signal has a plurality of first frequencies including a first center frequency and the second on-chip signal has a plurality of second frequencies including a second center frequency, the signal conditioning circuit further comprising a first spectrum mirroring circuit operable to mirror the plurality of first frequencies of the first on-chip signal about the first center frequency to generate a first mirrored on-chip signal based on the first on-chip signal and a second spectrum mirroring circuit operable to mirror the plurality of second frequencies of the second on-chip signal about the second center frequency to generate a second mirrored on-chip signal based on the second on-chip signal.

16. The network element of claim 15, wherein the first spectrum mirroring circuit comprises a first mixer operable to mix the first on-chip signal with a first local oscillator (LO) signal having a first LO frequency double the first center frequency and the second spectrum mirroring circuit comprises a second mixer operable to mix the second on-chip signal with a second LO signal having a second LO frequency double the second center frequency.

17. The network element of claim 15, wherein the first spectrum mirroring circuit comprises a first mixer, a first low-pass filter, and a second mixer, and the second spectrum mirroring circuit comprises a third mixer, a second low-pass filter, and a fourth mixer, wherein:
the first mixer is operable to mix the first on-chip signal with a first local oscillator (LO) signal having a first LO frequency equal to the first center frequency plus or minus a first on-chip frequency to generate a first intermediate signal based on the first on-chip signal and the first LO signal, the first low-pass filter being operable to attenuate at least one of the plurality of first frequencies of the first intermediate signal above a first cutoff frequency to generate a first filtered intermediate signal based on the intermediate signal, the second mixer being operable to mix the first filtered intermediate signal with a second LO signal having a second LO frequency equal to the first center frequency minus or plus the first on-chip frequency to generate the first mirrored on-chip signal; and
the third mixer is operable to mix the second on-chip signal with a third LO signal having a third LO frequency equal to the second center frequency plus or minus a second on-chip frequency to generate a second intermediate signal based on the second on-chip signal and the second LO signal, the second low-pass filter being operable to attenuate at least one of the plurality of second frequencies of the second intermediate signal above a second cutoff frequency to generate a second filtered intermediate signal based on the intermediate signal, the fourth mixer being operable to mix the second filtered intermediate signal with a fourth LO signal having a fourth LO frequency equal to the second center frequency minus or plus the second on-chip frequency to generate the second mirrored on-chip signal.

18. The network element of claim 11, wherein the at least one of the first inbound electrical interface, the second inbound electrical interface, the first outbound electrical interface, and the second outbound electrical interface further comprises a tapered waveguide having a first taper end and a second taper end, the first taper end being configured to be coupled to one of the first inbound THz waveguide, the second inbound THz waveguide, the first outbound THz waveguide, and the second outbound THz waveguide and having a first effective mode area, the second taper end being configured to be coupled to at least one of the first inbound antenna, the second inbound antenna, the first outbound antenna, and the second outbound antenna and having a second effective mode area smaller than the first effective mode area.

19. The network element of claim 11, further comprising a substrate having a planar surface on which the signal conditioning circuit is disposed, at least one of the first inbound antenna, the second inbound antenna, the first outbound antenna, and the second outbound antenna having a major axis and a minor axis, the major axis extending orthogonal to the planar surface of the substrate.

20. The network element of claim 11, further comprising a substrate having a planar surface on which the signal conditioning circuit is disposed, at least one of the first inbound antenna, the second inbound antenna, the first outbound antenna, and the second outbound antenna having a major axis and a minor axis, the major axis extending coplanar with the planar surface of the substrate.
